(19) United States
(12) Patent Application Publication
(10) Pub. No.: US 2004/0093677 A1
(43) Pub. Date: May 20, 2004

(54) Golf-maid

(76) Inventor: Robert F. Zales SR., Panama City, FL (US)

Correspondence Address: ROBERT F. ZALES Sr., 1705 TYNDALL DRIVE, PANAMA CITY, FL, 32401, US

(21) Appl. No.: 10/376,014

(22) Filed: Mar. 3, 2003

Related U.S. Application Data
(60) Provisional application No. 60/427,267, filed on Nov. 18, 2002.

(51) Int. Cl. A46B 13/02; B25B 21/00

(52) U.S. Cl. 15/23; 15/4; 7/138; 7/165

(57) ABSTRACT

A power operater “golf-maid” golfshoe cleat cleaning tool. Having a rotating brush connected by a steel hexgon shaft on one end of the brush and two pins on the forward end, to be used to remove and or replace the leats quicker and eaiser than the existing equipment. The “golf-maid” can also be used by the golfer after he is through playing to clean his shoes before placing them in his vehicle. In order to keep the vehicle clean, the “golf-maid” is battery operated and can be carried in the golfers bag.

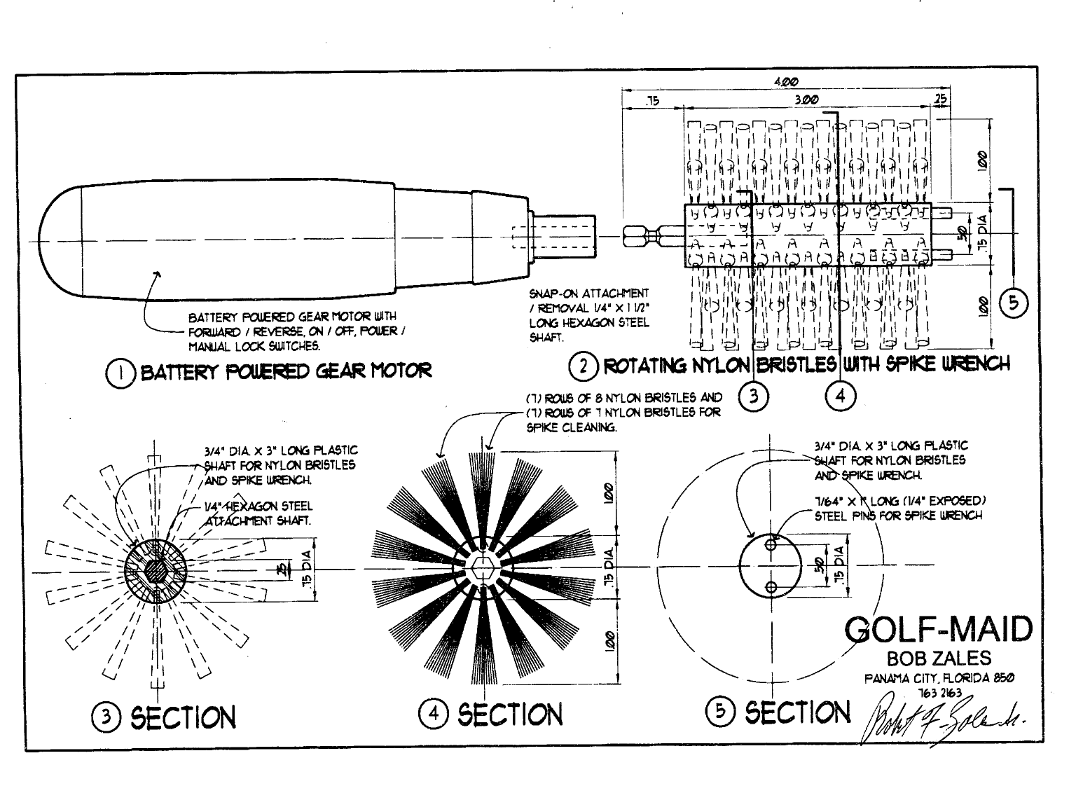

This invention is a battery powered tool, that primary purpose is to remove mud, dirt, and other debris' from the soft cleats, as well as the standard cleats from golf shoes, it can also be used by football and baseball players shoe cleats. It also has steel pins in the forward end in order to also be able to remove and replace golfshoe cleats. It has a forward and reverse switch as well as a locking device, for looseing tight cleats. The invention is composed of the power supply, a rotating brush, a hex type steel rod, and two steel pins.

The main reason I developed this invention was due to the fact that as of the time I first made a prototype was beacause there was never any device that could do the work this invention does, is because the only way the golfers had to do the same thing this does was by hand, with one of two hand held tools, one being a small plate with tips on it and or a T-bar, both taking a lot more time to accomplish the job, which had a tendency to hold other golfers up on the course. Not being able to remove the debres, mud, and dirt from the cleats, caused the golfer to lose his stance, causing him to misplay his shot. By being power operated and able to carry in the golfers bag, they can clean the cleats in a few seconds, not holding up the other golfers, this can be done after just 3 or 4 holes. The only other cleat cleaner is normally at the clubhouse an can only be used after each nine holes. This invention also allows the golfer to clean his shoes after playing, keeping him from having to clean his vehicle after he finishes.

I claim:

1. A battery operated power golf tool, with a forward and reverse switch, and a locking devise on the forward end a ¼Δ hollow, hexigon shaft on the forward end.

2. A rotating nylon bristles.

3. A plastic shaft to hold the nylon bristles, with a spike wrench on the forward end, and a ¼″ steel hexigon shaft secured in the rear end.

4. The rotating brush will be used to clean clogged, mud, dirt and debres' from the golfshoe spikes, cleats and golfshoes, football and baseball cleats.

5. Two steel spike pins secured on front end of brush shaft, to be used to replace and or remove old cleats, according to claim 3.

6. A spare brush will be available when and if original brush weres out.

7. A golfshoe tool comprising a plurality of a first body member; a second, third, fourth, fifth, body memebers, named “golf-maid”.
